(19) United States
(12) Patent Application Publication
(10) Pub. No.: US 2003/0056884 A1
(43) Pub. Date: Mar. 27, 2003

(54) Heat and moisture exchange media

(76) Inventors: William A. Belding, Auburn, CA (US); R. Kirk Collier, Reno, NV (US)

Correspondence Address: ANDREW ALEXANDER & ASSOCIATES, 3124 KIPP AVENUE, P.O. BOX 2038, LOWER BURRELL, PA, 15068, US

(21) Appl. No.: 10/233,532

(22) Filed: Sep. 4, 2002

Related U.S. Application Data
(60) Provisional application No. 60/324,693, filed on Sep. 26, 2001.

(51) Int. Cl. B31F 1/22

(52) U.S. Cl. 156/205; 156/210

(57) ABSTRACT

A method of making a sensible and latent heat exchange media having a multiplicity of passages therethrough through which an air stream can flow, the method comprising impregnating a solution containing at least one of the group consisting of sodium silicate and potassium silicate into corrugated cellulosic paper to provide silicate impregnated paper and reacting the silicate in the impregnated paper using a gas such as CO₂ or an acid such as boric acid to form a silica gel desiccant, thereby forming a sensible and latent exchange media.

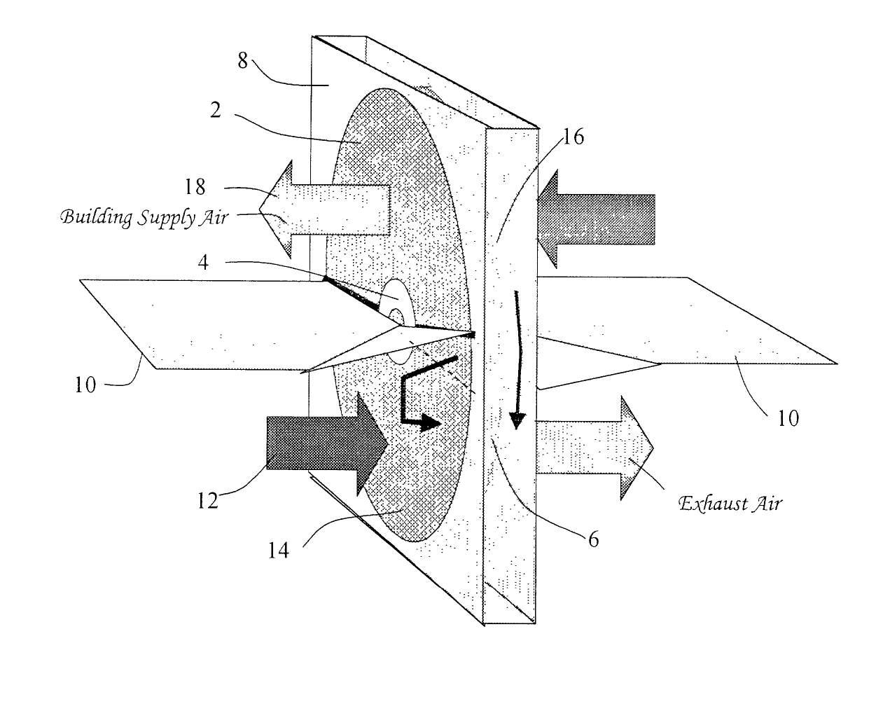

### CROSS REFERENCE TO RELATED APPLICATIONS

This application claims priority to U.S. Provisional Application Serial No. 60/324,693, filed Sep. 26, 2001.

### BACKGROUND OF THE INVENTION

This invention relates to a heat exchange media by which sensible and latent heat (moisture) are exchanged.

Typically a heat exchange media is incorporated into a rotating wheel in a wheel enclosure or cassette that is fitted with air ducts running parallel to the axis of the wheel. Usually, the wheel is divided so that air is introduced to two or more segments of the wheel and ducts are fitted to direct the air to or from those segments. In one embodiment, the wheel may be split diametrically into two equal segments, with the two air ducts fitted to direct the air to the two segments of the wheel.

Heat exchange wheels can be designed to exchange only sensible heat (no moisture) or to exchange both sensible and latent heat where moisture is exchanged. Wheels that exchange both heat and moisture are referred to as enthalpy exchange wheels or total energy wheels. In the case where an enthalpy wheel is used to recover energy from a building space, the exhaust air from the building is passed through one side of the wheel and fresh outdoor air is passed countercurrent through the other side. In summer, the hot moisture-laden outdoor air enters one side of the wheel and the cooler and dryer indoor air is exhausted through the other side. In winter, the cold dry outdoor air is difficult to corrugate at high processing speeds leading to high manufacturing costs.

U.S. Pat. No. 5,500,402 discloses a method of manufacturing of an enthalpy exchanger by forming silica gel in a support matrix. The substrate is impregnated with: (1) waterglass, (2) acid to form a silica gel, (3) basic chemical solution to increase the pore size of the silica gel, and then exposed to a stabilizing solution of inorganic salts. However, the present does not require stabilization because it is not thermally reactivated.

U.S. Pat. No. 5,580,369 discloses an improved adsorbent composition for a natural gas-fired, adsorption cooling system that readily adsorbs moisture from ambient air, while being readily regenerated at high temperatures up to 200°-300° C. in order to provided an enhanced coefficient of performance to the system. Such an adsorbent composition may comprise an A-type zeolite, an X-type zeolite or a chemically modified Y-type zeolite either alone, in conjunction with each other or in conjunction with alumina and/or silica gel. A rotating adsorbent wheel may be fashioned from conjugated paper comprising the adsorbent composition and a slurry of synthetic, organic fibers which are preferably polyaramid fibers. The strength of the wheel may be enhanced by surface treating it with sols or salt solutions of alumina or silica, and a highly temperature-stable epoxy or phenolic resin.

U.S. Pat. No. 4,341,559 discloses binder compositions based upon aqueous solutions of alkali metal silicates. More particularly, this invention is directed to binder compositions consisting essentially of (a) aqueous alkali metal silicate solutions having a molar ratio of SiO₂:Me₂O of from about 2.0:1 to 3.4:1, with Me signifying an alkali elastic material and a moisture-permeable film to thereby provide a dehumidifying material having an elastic layer or bed therein. The dehumidifying material may be used in the fields of packing articles such as precision machines and dehydrated food and of dehumidification of beds, cushions, seat covers, lockers and the like.

In spite of these disclosures, there is still a great need for an improved beat and moisture exchange media which is economical to produce.

### SUMMARY OF THE INVENTION

It is the object of this invention to provide and improved adsorbent media, e.g., paper and adsorbent, for enthalpy exchange.

It is another object of this invention to provide improved methods of impregnating or coating the surface of the inner channels of enthalpy exchange media.

It is further object of this invention to provide an enthalpy exchange media having a low pressure drop.

It is further object of this invention to provide a desiccant matrix that will maintain a high effectiveness for enthalpy exchange with low levels of desiccant in the matrix.

It is another object of this invention to provide a desiccant media having greatly reduced costs.

Yet it is a further object of this invention to provide an enthalpy exchange media having no support for flame propagation.

It is still a further object of the invention to provide an enthalpy exchange media for maintaining structural integrity in a liquid water environment.

And, still it is another object of this invention to provide a desiccant media that is resistant to mold and mildew when exposed to high relative humidity for extended periods of time.

In accordance with these objects, there is disclosed an enthalpy exchange media that is formed from a matrix of corrugated, or otherwise fluted, cellulosic paper which is impregnated or coated with a desiccant containing composition, the flutes of the media having parallel channels that form passageways for the flow of air or other gas. The media may be either simultaneously treated or subsequently treated with a compound That inhibits or eliminates mold and mildew formation at high humidities.

Also disclosed is a method of making a sensible and latent heat exchange media having a multiplicity of passages therethrough through which an air stream can flow. The method comprises the steps of providing a stack of cellulosic corrugated paper layered upon itself to provide a multiplicity of passageways through the stack. The stack may comprise a wheel. The stack is dipped into a solution containing at least one of the group consisting of sodium silicate and potassium silicate to impregnate sodium silicate or potassium silicate into the corrugated paper which is reacted to form a silica gel desiccant in the paper to form the sensible and latent heat exchange media.

The corrugated paper may be treated with sodium or potassium silicate solution prior to layering or the paper may be treated prior to corrugating. Thereafter, the paper is corrugated and layered before reacting to form the silica gel desiccant in situ. This method has the advantage that the silica gel desiccant also acts as an adhesive to bind the layers of corrugated paper together. The paper is comprised of 30% to 100% cellulose, preferably 60% to 100% cellulose. Further, the solution contains 5 to 35 wt. %, preferably 12 to 20 wt. %, sodium or potassium silicate. The reacting of the silicate may be accomplished by exposing or treating with CO₂ gas or treating with an acidic solution typically having a pH in the range of 2 to 5.5. Preferred acids suitable for such use include boric acid, sulfuric acid, acetic acid, formic acid or hydrochloric acid because of low cost and ability to impart flame retardancy.

A sensible and latent heat exchange media is disclosed having a multiplicity of passages therethrough through which an air stream can flow. The media is comprised of a stack of cellulosic corrugated paper layered upon itself to provide a multiplicity of passageways through the stack. A silica gel desiccant is formed in situ in and/or coated on the paper, thereby forming a sensible and latent heat exchange media.

Also disclosed is another method of making a novel sensible and latent heat exchange media having a multiplicity of passages therethough through which an air stream can flow. The method comprises the steps of providing a stack of cellulosic corrugated paper layered upon itself to provide a multiplicity of passageways through the stack. A water based slurry comprised of a calcium silicate containing material and desiccant is provided. A coating of the slurry is applied to the corrugated paper and the coating is cured and dried to form a sensible and latent heat exchange media.

### BRIEF DESCRIPTION OF THE DRAWING

The FIGURE is a schematic of a heat and moisture exchange wheel.

### DESCRIPTION OF THE PREFERRED EMBODIMENTS

Referring to the FIGURE, it will be seen that an enthalpy exchange wheel consists of a central hub 4 on which a single-faced corrugated media is spirally wound to provide fluted channels parallel to the central axis or hub 4 of the wheel. A band 6 is placed around the outer layer of media to contain the media. Optionally, radial spokes (not shown) may be used with large diameter wheels to provide support and prevent deformation of the wheel. The wheel is contained within a cassette or mechanical frame 8 that has cross members supporting the central wheel shaft. Alternately, roller bearings may be provided for supporting the outer rim of the wheel resulting in elimination of the central hub and shaft. Also contained in the cassette or mechanical frame is a drive motor that is connected via a drive belt or chain to the wheel. The drive belt or chain typically will drive the outer diameter of the wheel although it may drive the central shaft or rollers, if used. The cassette also provides means for attaching ductwork to the face of the wheel. The ductwork splits the wheel into two or more sections. Ductwork 10 is shown dividing the wheel to separate incoming air from exhaust air, for example. To prevent leakage, seals may be placed in close proximity to the wheel face without significant contact with the wheel face. This reduces or eliminates drag from the seals and requires less motor energy than required for contact seal. Leakage at the face is minimized by close tolerances between the seal and face of the wheel. The FIGURE shows building exhaust air 12 entering first side 14 of the wheel, passing through the wheel and exiting the building. Outdoor air enters second side 16 of the wheel passing through the wheel and entering the building as building supply air 18. Blowers (not shown) are used to move the air or gas. Blowers can be configured in various push or pull combinations.

A purge section may optionally be added to the wheel to prevent cross contamination of the supply by the exhaust air. Purging is normally accomplished by directing outdoor air through a small wedge of the wheel following the exhaust section as the wheel rotates. This purge air is then dumped into the inlet of the exhaust side of the wheel and ultimately exits the building. The faster the wheel turns, the larger the purge section required to prevent crossover contamination.

The enthalpy exchange wheel media of the invention is comprised of a single-faced corrugated matrix whose surfaces are coated or impregnated with desiccant. The support matrix is comprised of a cellulosic paper that has been formed by combining a flat sheet and a fluted sheet to make a single faced corrugated structure. The single faced structure can then be stacked or wound on a hub to create the channeled media. Although different matrix materials can be used, the preferred sheet material of this invention is cellulosic paper. Kraft) paper, referred to herein as a cellulose based paper product, is typically available as single-faced corrugated media and may be used. Starch may be added to the paper during its manufacture and is typically used for adhering the fluted sheet to the flat liner sheet during corrugation. The use of starch can present problems by contributing to the formation of mold and/or mildew and its attendant problems of clogging channels. It has been discovered that the addition of a biocide to the matrix greatly minimizes the problem of mold and mildew formation. Organic biocides typical of those used in the paper industry can be used. Since organic biocides can degrade with time, it has been discovered that certain soluble zinc or copper compounds such as zinc acetate, zinc chloride, copper acetate and copper can be applied by spraying or immersion and are successful in inhibiting mold and mildew. Thus, the zinc or copper compounds can be present in the range of 0.01 to 2 wt. %.

Another method of this invention for eliminating or reducing mold and mildew formation is to minimize or eliminate starch in the media. This can be accomplished by using non-starch adhesives in paper manufacture, corrugation and subsequent wheel wrapping operation. For corrugation, one such adhesive is sodium silicate. Also, it has been discovered that other polymeric adhesives such as acrylic or styrene butadiene rubber lattices can also be used.

The desiccant containing media of this invention is one that exhibits a high rate of adsorption and correspondingly low Lewis Number. The Lewis Number is defined as the ratio of mass transfer resistance to heat transfer resistance. When the Lewis number is 1.0 the transfer of moisture occurs as effectively as the transfer heat in the media. It is, therefore, highly desirable to have a media that exhibits a Lewis number of 1.0, with a range of 1 to 2.5 being acceptable.

Energy exchange wheels operate at rotational speeds 60 to 200 times those of thermally regenerated dehumidification wheels. A speed of 30 RPM, gives an adsorption time of only 1 second. Because of the short adsorption and desorption times for energy exchange wheels, the amount of moisture exchanged on each revolution is minimal. For example, at ARI conditions, uptake per revolution is only about 0.00015 lb H₂O/lb matrix for a typical wheel with a rotational speed of 30 RPM and 600 ft/min air velocity. However, the rate of moisture uptake and moisture release is very important and will have a large bearing on the latent effectiveness of the wheel. The rate of mass (moisture) transfer is reflected in the Lewis number of the matrix material.

To determine adsorption rate and Lewis number, a moisture balance was set up with a sample tube through which air of controlled humidity was passed. A paper specimen of fixed dimension was suspended from a wire flame supported by the balance pan. Two air streams were configured to feed into the sample cell. Air stream “A”, the dry air stream, was conditioned by compressing the air and running it through a demister giving approximately 25% RE. Air Steam “B” was conditioned by passing it through a water saturator resulting in approximately 90% RH. “A” and “B” could each be diverted to a wet bulb cell to accurately determine wet bulb and dry bulb temperatures so that humidity could be calculated. The preconditioned air passed through flow meters and into the balance chamber through a transparent tube that surrounded the specimen. The bottom of the tube was open allowing the air to exit. The analytical balance used was a Mettler AE200 balance capable of reading to 0.0001 grams.

The following detailed experimental procedure was used to determine adsorption rate:

1. The weight of the wire support (without specimen) was determined using the analytical balance with the flow tube removed.

2. The specimen was configured as a flat coupon of 3″×1.5″ Typically a coupon of this size weighed approximately 0.3 to 0.6 grams The coupon was bent longwise down the middle at 90° to provide rigidity and suspended vertically on the wire support resting on the balance pan.

3. The dry air flow meter was set to 10 cfh giving approximately 10 fpm linear velocity in the 1.75″ I.D. tube entering the balance.

4 The dry air was temporarily directed into the wet bulb cell and, after minimum equilibration time of 5 minutes, dry and wet bulb temperatures are recorded.

5. The dry air steam was redirected to the air tube surrounding the specimen. The specimen and wire support were checked for clearance, assuring that they did not contact the walls of the tube.

6. The sample was allowed to equilibrate with the dry air for a minimum of 40 minutes or longer if the sample weight had not stabilized.

7. Without removing the specimen from the tube, the wire Support and specimen were raised above the balance pan and the balance was zeroed. The wire support and specimen were then lowered onto the pan and the total weight was recorded. The equilibrated specimen weight at the dry air condition was this weight minus the wire weight determined in Step 1.

8. The balance was zeroed again for the start of the experiment.

9. The dry air stream was then turned off and the wet air stream was set to 10 cfh. At the same time a stopwatch was started. Weight gains were then recorded with time with more frequent readings in the beginning of the test and less frequent readings as the sample approaches equilibrium.

10. After 5 minutes from the start of the test, the temperature of the saturated air leaving the saturator and the dry bulb temperature entering the sample tube were recorded.

11. After 30-40 minutes, depending on the adsorption rate of the specimen, equilibrium was reached as indicate by the weight becoming stable. The test was then terminated and the saturated air stream was closed off.

Data were entered into a spreadsheet and an uptake vs. time curve was generated. From the adsorption rate data, the Lewis Number was determined. The Lewis Number is defined as the ratio of the mass transfer resistance to the heat transfer and can be determined by matching actual dynamic adsorption rate curves against theoretical adsorption rate curves generated from a range of Lewis Numbers.

Silica gel is available commercially in powder form from a variety of manufacturers. Silica gel can also be prepared in-situ by dipping or spraying silica containing solutions preferably containing 5 to 35 wt. % sodium silicate. Typically this is accomplished by first dipping the corrugated support in a basic solution (pH=10.5 to 13.5) such as sodium silicate (water glass) or potassium silicate preferably at about room temperature to about 112° F. This is then followed by applying an acidic solution that reacts with the sodium or potassium in the silicate forming a salt and silica gel, preferably about room temperature. Under controlled pH conditions, e.g., pH in the range of 2.0 to 5.5, the silica gel that is formed develops a microporous structure (pore size about 18 to 40 μm), thus providing a high surface area for adsorption. Water washing can be used to remove residual salts. This in-situ method has the advantage that it avoids use of a high-cost manufactured desiccant. In addition, silica gel formed in situ functions not only as a desiccant but also as a binder, improving both the dry and wet strengths of the media. A drying step may be necessary between immersions to avoid over-wetting and washout of the desiccant formed. Drying may be accomplished by applying air at room temperature up to 112° F.

An improved method of the present invention includes in-situ formation of silica gel and avoids the multiple impregnation and drying steps. A basic silicate solution such as sodium silicate is applied to the wheel. The solution can be applied by immersion after winding or by spraying before winding. It has been discovered that the sodium silicate treated paper alone exhibits sufficient adsorption capacity but can have a low adsorption rate, resulting in a high Lewis Number and low moisture exchange. Surprisingly, it has been found that if the media, e.g., cellulose paper treated with sodium silicate, is subsequently exposed to CO₂ gas, the sodium silicate sets quickly without dipping in the acid solution. Further, the CO₂ treatment substantially increases the adsorption rate of the media and reduces the Lewis number to less than 2.5. It has been discovered that the CO₂ may be applied at ambient temperature or heated to accomplish drying simultaneously. The CO₂ treatment thus avoids subsequent additional drying and washing steps.

A second method utilizes the use of boric acid for neutralization. Although this does not avoid multiple impregnations or applications, it has been found that washing steps are unnecessary when boric acid is used. On neutralization with boric acid, sodium borate is formed which functions as a flame retardant in the cellulose product. The boric acid is, therefore, performing a unique dual role functioning as both a neutralizing agent and a flame retardant.

A third method utilizes a source of calcium silicate such as “Portland cement” as a binder. The cement is co-mixed with desiccant and water to form a water slurry which is applied to the surface by spraying or immersion. The slurry contains 10 to 50 wt. % calcium silicate and 3 to 35 wt. % desiccant, the remainder water. After application, the matrix, with coating, is cured under high humidity and subsequently dried at temperatures in the range of 70° to 100° F. Since the applied coating can become brittle after curing and drying, a preferred method of application includes immersion in cement/desiccant slurry after the wheel is wound. After coating, the corrugated media is removed and drained. Excessive buildup of slurry blocking the channels media can then be removed by shaking or vibrating the media or by blowing air through the channels.

The preferred processes of the invention are as follows:

Process #1: In-situ Silicate Process Using CO₂

1. Single-faced corrugated paper is spirally wrapped on a central hub to the diameter desired. Simultaneously, the paper is trimmed to provide the desired wheel depth and create freshly cut undamaged flute openings. Adhesive may be applied to the tips of the flutes to prevent movement layer-to-layer. An outer band is installed to reinforce the wheel.

2. Alternatively, the corrugated paper can be cut and stacked into blocks for later assembly into a wheel shape.

3. For large wheels, spokes can be installed at the face connecting the hub to the outer band.

4. The formed wheel or blocks of media are then immersed in the basic silicate solution, removed and drained.

5. CO₂ gas is blown through the media so that the channel surfaces are exposed. This will clear any clogged channels from the immersion step. The CO₂ can be heated up to 220 ° F. to provide accelerated drying.

6. A soluble boron-containing or phosphate containing compound may optionally be added to enhance the flame retardancy of the wheel after drying.

7. A face treatment of abrasion resistant paint is applied to the wheel faces.

8. The wheel is installed into a cassette or blocks are cut to shape and installed into a wheel that is in turn installed into a cassette.

Process #2: In-situ Silicate Process Using Boric Acid

The first four steps are the same as in Process #1. Then:

1. The media is dried with air that is optionally heated.

2. The media is immersed in a boric acid solution.

3. The media is dried with air that is optionally heated.

4. A face treatment of abrasion resistant paint is applied to the wheel faces.

5. The wheel is installed into a cassette or blocks are cut to shape and installed into a wheel that is in turn installed into a cassette.

Process #3: Portland Cement Binder

The first three steps are the same as in Process #1. Then:

1. The formed wheel or blocks of media are immersed in or sprayed with a Portland cement or calcium silicate slurry containing dispersed desiccant powder, removed and drained. The preferred desiccants are clinoptilolite, chabasite, both naturally occulting zeolite desiccants, or 4A molecular sieve.

2. Excess desiccant-containing slurry is removed from the channels by shaking and/or externally-applied air flow through the channels. The degree of shaking and the face velocity of the air will depend upon the viscosity of the desiccant-containing slurry. The parameters of viscosity, g-forces, and air flow velocity are varied such that a resultant desiccant-containing slurry film thickness remaining on the media be between 0.005 and 0.020 inches.

3. The desiccant-containing slurry is allowed to cure on the media in a high relative humidity environment for a period of preferably 4 to 7 days at preferred temperatures in the range of 80° to 120° F.

4. The media is dried with air that is optionally heated until thermal and moisture equilibrium with the media is achieved. The time required for drying will vary depending on the temperature of the air, but usually range from 10 minutes to 4 hours.

5. A face treatment of abrasion resistant paint is applied to the wheel faces.

6. The wheel is installed into a cassette or blocks are cut to shape and installed into a wheel that is in turn installed into a cassette.

Sodium silicate for use in the invention is as follows:

The formula for sodium silicate is Na₂O.(SiO₂)ₓ

Practical solutions can be prepared in range of x=0.4 to 4.0

Preferred starting solutions have x=1.60 to 3.25,

Percent Na₂O ranges from 9.22 to 16.35

Percent SiO₂ from 26.2 to 30%

High silica compositions are more viscous but require less acid for neutralization. Starting solution can range from x=3.22, % Na₂O=8.9%, SiO₂=30%, the solution has a syrupy consistency and is stable for extended periods of time as long as it is kept from freezing. This solution is supplied in stable form by PQ Corporation as Sodium Silicate N.

The starting solution (Sodium Silicate N) can be diluted immediately before using to reduce viscosity for spraying or dipping. Small flute sizes require lower viscosity solutions than large flute sizes. Penetration into the cellulose paper matrix is also faster with low viscosity solutions but when too dilute the matrix can become soggy and weak during processing. For dipping and spraying it has been found that a workable range of dilutions for the staring solution is from 0.3:1 to 3:1 water to starting solution. A more preferred range is 0.5:1 to 1.5:1 and the best dilution ratio appears to be 0.9:1.

The amount of silica, SiO₂, content in the matrix is from 5 to 30%. The preferred composition is in the range of 15 to 22% SiO₂. The optimum based on cost performance, is about 20% SiO₂. Depending on the porosity of the cellulose paper, pickup of the sodium silicate solution will range from 100 to 200% by weight, preferably 150% to 190%. On drying, use of 0.9:1 dilution ratio with a typical uncalendared Kraft paper typically gives about 20% SiO₂.

Gas or Acids for Neutralization:

CO₂—expose to 30% to 100% CO₂ gas (preferred >95%), for period of over 10 minutes or more (e.g., 30 minutes or more), the reaction is self regulating and slows down as equilibrium neutralization is reached.

Preferred Mineral acids—H₂SO₄, HNO₃, HCl, H₃BO₃

Preferred Organic acids—acetic, formic

Amount of acid needs to be sufficient for neutralization in range of pH=2.5 to 8.0. Less than pH 2.5, may cause breakdown of cellulose. Preferably, pH range is 4.0 to 7.0. Also, the more acidic the paper, the greater the need for washing adding additional processing. Preferable acid equivalents should be in the range of 1 to 1.5 equivalents of acid per equivalent base (Na₂O or K₂O). Absolute acid strength will depend on the mass of solution used per mass of paper being treated.

The following examples are illustrative of the invention:

### EXAMPLE 1

A solution was prepared by mixing 110.3 g of Sodium Silicate N from PQ Corporation containing 28.7% SiO₂ and 8.3% Na₂O with 100.7 g of deionized water. A coupon of single-faced corrugated white bleached Kraft paper having a basis weight of 50 lb/3000 ft² and a caliper (thickness) of 0.005 inches was immersed in the solution for a period of 5 seconds, removed and drained. After draining the sample was placed in a chamber where CO₂ gas (>99% pure) was flowed through. After the 30 minutes the coupon was removed and found to be dry. The sample contained 20.3% SiO₂. The sample was tested for adsorption rate and found to exhibit a Lewis number of 1.7. This compared favorably to commercial sample with a Lewis number of 2.3 indicating slower adsorption.

### EXAMPLE 2

A solution was prepared by mixing 110.3 g of Sodium Silicate N from PQ Corporation containing 28.7% SiO₂ and 8.3% Na₂O with 100.7 g of deionized water. A second solution was prepared by dissolving 6.0 g of H₃BO₃ in 144 g of deionized water. The water was heated to improve Solubility of the boric acid. A coupon of single-faced corrugated white bleached Kraft paper having a basis weight of 50 lb/3000 ft² and a caliper (thickness) of 0.005 inches was immersed in the first solution for a period of 5 seconds, removed and drained. The coupon was then immersed in second solution for a period of 5 seconds and drained. The coupon was allowed to air dry and tested for adsorption rate. Although the sample gave a higher Lewis number (2.12) than the coupon of Example 1, its performance was improved over the comparative example and its fire retardancy was expected to be improved over the coupons containing no boric acid.

### EXAMPLE 3

A mixture of 300 gr of water, 205 gr of Portland cement, and 138 gr of 4A molecular sieve was prepared. This mixture was poured through the open passages of the wound corrugated Kraft paper matrix using gravity to flow the mixture completely through the matrix. The matrix was then shaken until the build-up of accumulated mixture at the exit of the open passages has been eliminated resulting in an even coating of mixture within the passages of the matrix.

The matrix with coated channels was then cured in an enclosed container maintaining >99% relative humidity at a temperature of 80 degrees F. for a period of 7 days. After curing, the finished matrix was allowed to dry in ambient air overnight.

While the invention has been described in terms of the preferred embodiments, the claims appended hereto are intended to encompass other embodiments that fall within the spirit of the invention.

Having described the presently preferred embodiments, it is to be understood that the invention may be otherwise embodied within the scope of the appended claims.

What is claimed is:

1. A method of making a sensible and latent heat exchange media having a multiplicity of passages therethrough through which an air stream can flow, the method comprising the steps of:
(a) providing a stack of cellulosic corrugated paper layered upon itself to provide a multiplicity of passageways through said stack;
(b) dipping said stack into a solution containing at least one of the group consisting of sodium silicate and potassium silicate to impregnate sodium silicate or potassium silicate into said corrugated paper; and
(c) reacting said silicate in said layered impregnated paper to form a silica gel desiccant in said paper; and
(d) drying using a temperature range of room temperature to 112° F., thereby forming a sensible and latent exchange media having a Lewis number in the range of bout 1 to 2.5.

2. The method in accordance with claim 1 wherein said solution contains 5 to 35 wt. % sodium silicate.

3. The method in accordance with claim 1 wherein said cellulosic paper contains 30 to 100 wt. % cellulose.

4. The method in accordance with claim 1 wherein an acidic solution having a pH in the range of 2 to 5.5 is used for said reacting.

5. The method in accordance with claim 1 wherein said reacting is performed by exposing said paper impregnated with sodium silicate or potassium silicate to CO₂.

6. The method in accordance with claim 4 wherein said acidic solution is selected from boric acid, sulfuric acid, acetic acid and hydrochloric acid.

7. The method in accordance with claim 1 wherein said stack of cellulosic corrugated paper comprises a wheel.

8. The method in accordance with claim 1 including, after said reacting, washing said stack to remove residual salts therefrom.

9. The method in accordance with claim 1 including treating said media with a compound selected from the group consisting of a water soluble zinc and copper compound.

10. A sensible and latent heat exchange media having a multiplicity of passages therethrough through which an air stream can flow, the media comprised of:
(a) a stack of cellulosic corrugated paper layered upon itself to provide a multiplicity of passageways through said stack; and
(b) a silica gel desiccant impregnated in and coated on said paper, thereby forming a sensible and latent heat exchange media.

11. A method of making a sensible and latent heat exchange media having a multiplicity of passages therethrough through which an air stream can flow, the method comprising the steps of:
(a) providing a single faced corrugated cellulosic paper;
(b) impregnating a solution containing at least one of the group consisting of sodium silicate and potassium silicate into said paper to provide silicate impregnated paper;
(c) layering said silicate impregnated paper to provide layered silicate impregnated paper
(d) reacting said silicate in said layered impregnated paper to form a silica gel desiccant in said paper; and
(e) drying using a temperature range of room temperature to 112° F., thereby forming a sensible and latent exchange media having a Lewis number in the range of bout 1 to 2.5.

12. The method in accordance with claim 11 wherein said solution contains 3 to 35 wt. % sodium silicate.

13. The method in accordance with claim 11 wherein said cellulosic paper contains 30 to 100 wt. % cellulose.

14. The method in accordance with claim 11 wherein an acidic solution having a pH in the range of 2 to 5.5 is used for said reacting.

15. The method in accordance with claim 11 wherein said reacting is performed by exposing said paper impregnated with sodium silicate or potassium silicate to CO₂.

16. The method in accordance with claim 14 wherein said acidic solution is selected from boric acid, sulfuric acid, acetic acid, formic acid and hydrochloric acid.

17. The method in accordance with claim 11 wherein said stack of cellulosic corrugated paper comprises a wheel.

18. The method in accordance with claim 11 including, after said reacting, washing said stack to remove residual salts therefrom.

19. The media in accordance with claim 10 wherein the paper contains 5 to 35 wt. % silica gel.

20. The method in accordance with claim 1 including treating said media with a compound selected from the group consisting of a water soluble zinc and copper compound.

21. The media in accordance with claim 10 wherein said silica gel dessicant results from reacting sodium or potassium silicate with one of the group consisting of CO₂ gas and an acid.

22. A method of making a sensible and latent heat exchange media having a multiplicity of passages therethrough through which an air stream can flow, the method comprising the steps of:
(a) providing cellulosic paper;
(b) impregnating a solution containing at least one of the group consisting of sodium silicate and potassium silicate into said paper to provide silicate impregnated paper;
(c) corrugating said paper to provide a single face corrugated paper;
(d) layering said silicate impregnated paper to provide layered silicate impregnated paper; and
(e) reacting said silicate in said layered impregnated paper to form a silica gel desiccant in said paper, thereby forming a sensible and latent exchange media.

23. The method in accordance with claim 22 wherein said solution contains 5 to 35 wt. % sodium silicate.

24. The method in accordance with claim 22 wherein said cellulosic paper contains 30 to 100 wt. % cellulose.

25. The method in accordance with claim 22 wherein an acidic solution having a pH in the range of 2 to 5.5 is used for said reacting.

26. The method in accordance with claim 22 wherein said reacting is performed by exposing said paper impregnated with sodium silicate or potassium silicate to CO₂.

27. The method in accordance with claim 25 wherein said acidic solution is selected from boric acid, sulfuric acid, acetic acid, formic acid and hydrochloric acid.

28. The method in accordance with claim 22 wherein said stack of cellulosic corrugated paper comprises a wheel.

29. The method in accordance with claim 22 including, after reacting, washing said stack to remove residual salts therefrom.

30. The media in accordance with claim 22 wherein the paper contains 5 to 35 wt. % silica gel.

31. The media in accordance with claim 22 wherein cellulosic paper contains 30 to 100 wt. % cellulose.

32. The method in accordance with claim 22 including treating said media with a compound selected from the group consisting of a water soluble zinc and copper compound.

33. A method of making a sensible and latent heat exchange media having a multiplicity of passages therethough through which an air stream can flow, the method comprising the steps of:
(a) providing a stack of cellulosic corrugated paper layered upon itself to provide a multiplicity of passageways through said stack;
(b) providing a water based slurry comprised of calcium silicate and desiccant;
(c) applying a coating of said slurry to said conjugated paper;
(d) curing said coating; and
(e) drying said curled coating to form a sensible and latent heat exchange media.

34. The method in accordance with claim 33 wherein said desiccant is a desiccant selected from the group consisting of zeolites, activated bauxite, alumina, hydrotalcite, clinoptilolite, chabasite.

35. The method in accordance with claim 33 including curing under high humidity.

36. The method in accordance with claim 33 wherein said applying includes dipping said stack in said slurry or pumping slurry through said stack.

37. The method in accordance with claim 33 wherein calcium silicate is present in said slurry in the range of 10 to 50 wt. % based on the total weight of slurry.

38. The method in accordance with claim 33 wherein the desiccant is present in the range of 3 to 35 wt. % base in total weight percent of the slurry.

39. A method of making a sensible and latent heat exchange media having a multiplicity of passages therethrough through which an air stream can flow, the media resistant to mold or mildew formation, the method comprising the steps of:
(a) providing a stack of cellulosic corrugated paper layered upon itself to provide a multiplicity of passageways through said stack;
(b) treating said stack with a starch solution containing at least one of the group consisting of zinc and copper compounds to adhesively bond said media together to provide a corrugated media resistant to formation of mold or mildew.
